(19) United States
(12) Patent Application Publication
(10) Pub. No.: US 2010/0157908 A1
(43) Pub. Date: Jun. 24, 2010

(54) MOBILE RADIO COMMUNICATIONS DEVICE AND RELATED METHOD AND SYSTEM

(75) Inventor: Michael Roberts, Reading (GB)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/997,730

(22) PCT Filed: Aug. 18, 2006
(86) PCT No.: PCT/JP2006/316670

§ 371 Date: Feb. 25, 2008

(30) Foreign Application Priority Data
Aug. 18, 2005 (GB) 0516985.9

(51) Int. Cl. H04W 72/04

(52) U.S. Cl. 370/329

(57) ABSTRACT

The present invention provides for a mobile radio communications device arranged to support at least one of a High Speed Downlink Packet Access channel and an Enhanced Uplink Dedicated channel, including means for signalling to a network controller the said support of at least one of the those channel and means for determining a circuit switched connection is required, the device being arranged to signal the said support of the at least one channel when a circuit switch connection is required, so that a radio network controller of a mobile radio communications device network can allocate the said at least one of the channels for circuit switched signalling exchanges.

The present invention relates to a mobile radio communications device and related method and system employing a mobile radio communications device network.

Mobile radio communication device networks employ a variety of forms of signalling for exchanges between the mobile radio communications devices connected to the network and network elements such as the radio network controller. For current so-called third generation networks, the Third Generation Partnership Project (3GPP) has defined, by way of an on-going series of releases, a variety of standards to which network operators and equipment suppliers must conform.

Within a mobile radio communications device network, a requirement for Circuit Switch (CS) signalling often arises although the current manner of user equipment and network operation and signalling is such as to exhibit disadvantageous limitations.

For example, from the release R99 according to the 3GPP, problems arise in relation to the Dedicated Physical Channel (DPCH) employed in accordance with that release. For example, it is found that, at a transmission speed of 3.4 kbps, the DPCH can prove disadvantageously slow leading likewise to a disadvantageous delay in CS call set-up times. Yet further, CS signalling capacity limitations are also experienced.

Further, through the use of an Enhanced Uplink Dedicated Channel (EDCH) and which is found from the release Rel-6 of the 3GPP specification, further limitations can arise relating to the Radio Network Controller (RNC) processing load. In accordance with Rel-6, the RNC is required to allocate a R99 DPCH and also an EDCH in order to increase the signalling speed. Of course, in order to achieve such allocation of the R99 DPCH and the EDCH, it is necessary to disadvantageously double the Radio Resource Management (RRM) requirements.

Also, although F-DPCH was introduced in Rel-6 in an attempt to limit code-resource requirements within the packet switched domain, the above-mentioned problems associated with the use of the DPCH in relation to the CS domain have not been addressed.

The above-mentioned problems lead to disadvantageous performance limitations and inefficiencies.

The present invention seeks to provide for a mobile radio communications device and related method and system of operation, and related network devices, having advantages over known such devices, methods and systems.

According to a first aspect of the present invention, there is provided a mobile radio communications device arranged to support at least one of a High Speed Downlink Packet Access channel and an Enhanced Uplink Dedicated channel, including means for signalling to a network controller the said support of at least one of the those channel and means for determining a circuit switched connection is required, the device being arranged to signal the said support of the at least one channel when a circuit switch connection is required, so that a radio network controller of a mobile radio communications device network can allocate the said at least one of the channels for circuit switched signalling exchanges.

Preferably, the said means for determining that a circuit switched connection is required includes means for signalling from the mobile radio communications device that such a circuit switched connection is required.

According to another aspect of the present invention, there is provided a network control device for a mobile radio communications network and including means responsive to receipt of signalling from a mobile radio communications device indicating support for at least one of a High Speed Downlink Packet Access channel and an Enhanced Uplink Dedicated channel, and arranged to allocate a respective High Speed Downlink Packet Access channel or Enhanced Uplink Dedicated bearer to the mobile radio communications device for the exchange of circuit switched signalling.

Advantageously, the network controller device can be arranged to subsequently allocate a circuit switched bearer for circuit switched signalling exchanges with a mobile radio communications device.

In particular, the network controller as arranged to allocate a conventional dedicated channel for subsequent handling of the ongoing circuit switched signalling exchange.

Yet further the radio network controller can be arranged to modify measurement requirements within a cell so as to employ a cell configuration having regard to the particular circuit switched signals.

According to yet a further aspect of the present invention, there is provided a method of circuit switched signalling between a mobile radio communications device and a network controller within a mobile radio communications network, and including the step of employing one of a High Speed Downlink Packet Access channel and an Enhanced Uplink Dedicated channel for providing the circuit switched signalling.

In particular either one of the said channels can be employed at least for the initial stages of the circuit switched signalling.

In this manner, subsequent to an initial phase of the circuit switched signalling the method can include the step of using a conventional circuit switched connection for the ongoing circuit switched signalling exchanges.

The method can also include the step of the mobile radio communications device signalling its support of at least one of the said channels to a network controller within the network and, can subsequently comprise a step of at the network controller within the network responding to the said signalling of the support for the channels by allocating at least one of the said channels for the circuit switched signalling.

Yet further, the method can include the step of modifying, at a radio network controller, measurement requirements for a cell in order to configure the cell for the circuit switched signalling required.

According to a still further aspect of the present invention, there is provided a mobile radio communications system comprising at least one of a mobile radio communications device as defined above, and a network controller device as defined above.

As will be appreciated from the further discussion below, the present invention is advantageous since, in allowing for a selection of High Speed Downlink Packet Access and/or Enhanced Uplink Dedicated Channel bearers for initial circuit switched signalling exchanges, the above-mentioned speed-limitations and inefficiencies can advantageously be reduced.

To enhance the manner in which the present invention provides an improvement to the prior-art discussed above, it is advantageous that the mobile radio communications device indicate as early as possible its support for the High Speed Downlink Packet Access channel and/or the Enhanced Uplink Dedicated Channel so that the radio network controller can then allocate such channels for circuit switch signalling in a timely fashion.

The present invention is advantageously arranged to take advantage of signalling-support characteristics of a High Speed Downlink Packet Access channel or an Enhanced Uplink Dedicated Channel and arranged for use in relation to circuit switched signalling.

The invention is described further hereinafter with reference to the accompanying drawing in which illustrates a radio communications device system, and related operational elements, according to an embodiment of the present invention.

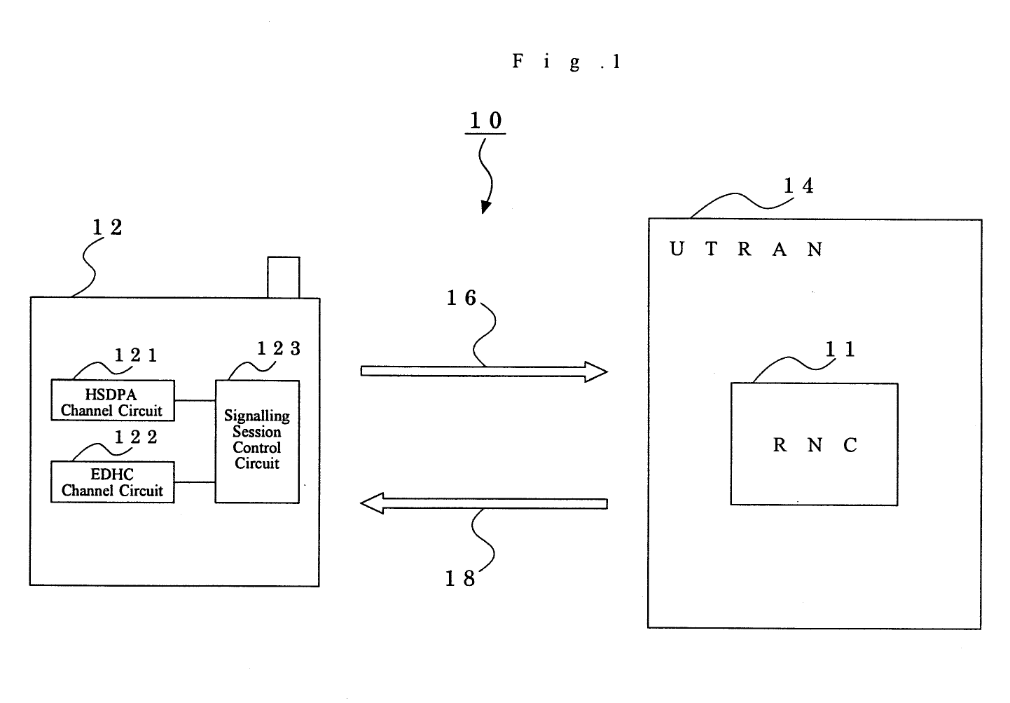

Within FIG. 1, there is illustrated a mobile radio communications system 10 as part of a mobile radio communications network and employing user equipment 12 in the form of a mobile radio communications device handset a UMTS Terrestrial Radio Access Network (UTRAN) 14 and, signalling 16, 18 arising in accordance with an embodiment of the present invention for establishment of signal switched signalling.

Initially, when the user handset 12 is required to send a connection management service request for establishing circuit switched signalling, which of course may arise either through responding to paging signals received at the handset 12 or, through the handset 12 seeking to initiate the communication session. The handset 12 is arranged to indicate its support for HSDPA and/or EDCH channels. It includes HSDPA channel circuit 121 and EDCH channel circuit 122. Such signalling is indicated by arrow 16 and is delivered to a RNC 11 of the UTRAN 14. The handset 12 is further arranged to provide an indication that a circuit switched signalling session control circuit 123 is also required.

The signaling session control circuit 123 carries the signalling to the RNC to support of at least one of the those channel and determines a circuit switched connection between the HSDPA channel circuit 121 or EDCH channel circuit 122 which is required.

Upon receipt of the signal 16 from the signalling session control circuit 123 of the handset 12, the RNC 11 within the UTRAN 14 is arranged to employ such information immediately to select HSDPA and/or EDCH bearers which are then allocated to the handset 12 for support of the required circuit switched signalling exchanges.

The initial stages of the circuit switched signalling from the signaling session control circuit 123 of the handset 12 to the network therefore occur on one of the HSDPA and EDCH channel circuits 121 and 122, and so the speed-limitations and inefficiencies arising within the prior-art are therefore advantageously reduced.

During subsequent operation of the initial stages of the circuit switched signalling exchanges, and once the conventional circuit switched bearer is located for allocation to the signalling exchange, the RNC 11 can be arranged to allocate such a conventional Dedicated Control Channel (DCCH) and other related Dedicated Channels (DCH) and upon which the ongoing circuit switched signalling exchanges can continue.

Through the support of HSDPA and EDCH channels at the handset 12, it will be appreciated that advantageously relatively high speeds, for example 2 Mbps for HSDPA cat. 5 channels, and EDCH channels, are available. As a further aspect of the illustrated embodiment, the RNC 11 within the UTRAN 40 can be arranged to modify the measurement requirements to adapt cell configuration having regard to the particular circuit switched services required.

Thus, as can be appreciated the concept of the present invention, by employing HSDPA and EDCH bearers to carry CS signalling between a mobile radio communications device and a related network, can lead to advantages in the manner in which at least initial stages of CS signalling from a handset are handled.

1. A mobile radio communications device arranged to support at least one of a High Speed Downlink Packet Access channel and an Enhanced Uplink Dedicated channel, including means for signalling to a network controller to support of at least one of the those channel and means for determining a circuit switched connection is required, the device being arranged to signal the said support of the at least one channel when a circuit switch connection is required, so that a radio network controller of a mobile radio communications device network can allocate the said at least one of the channels for circuit switched signalling exchanges.

2. A device as claimed in claim 1, wherein the said means for determining that a circuit switched connection is required comprises means for signalling from the mobile radio communications device that such a circuit switched connection is required.

3. A network controller device for a mobile radio communications network and including means responsive to receipt of signalling from a mobile radio communications device indicating support far at least one of a High Speed Downlink Packet Access channel and an Enhanced Uplink Dedicated channel and arranged to allocate a respective High Speed Downlink Packet Access channel or Enhanced Uplink Dedicated channel to the mobile radio communications device for the exchange of circuit switched signalling.

4. A network controller device as claimed in claim 3, and arranged to allocate a circuit switched bearer for subsequent circuit switched signalling exchanges with a mobile radio communications device.

5. A network controller device as claimed in claim 4 and arranged to allocate a conventional dedicated channel for subsequent handling of the ongoing circuit switched signalling exchange.

6. A radio network controller device as claimed in claim 3, 4 or 5, and arranged to modify requirements within a cell so as to employ a cell configuration having regard to the particular circuit switched signals.

7. A method of circuit switched signalling between a mobile radio communications device and a network controller within a mobile radio communications network, and including the step of employing one of a High Speed Downlink Packet Access channel and an Enhanced Uplink Dedicated channel for providing the circuit switched signalling.

8. A method as claimed in claim 7, wherein at least one of the said channels is employed at least for the initial part of the circuit switched signalling.

9. A method as claimed in claim 8, and subsequent to an initial phase of the circuit switched signalling, including the step of using a conventional circuit switched connection for the ongoing circuit switched signalling exchange.

10. A method as claimed in claim 7, 8 or 9, and including the step of the mobile radio communications device signalling its support of at least one of the said channels to a network controller within the network, and a step of, at a network controller within the network, responding to the said signalling of the support for the channels by allocating at least one of the said channels for the circuit switched signalling.

11. A method as claimed in claim 7, 8, or 9, and including the step of modifying, at a radio network controller, measurement requirements for a cell in order to configure the cell for the circuit switched signalling required.

12. A mobile radio communications system comprising: a mobile radio communications device arranged to support at least one of a High Speed Downlink Packet Access channel and an Enhanced Uplink Dedicated channel, including means for signalling to a network controller to support of a least one of the those channel and means for determining a circuit switched connection is required, the device being arranged to signal the said support of the as least one channel when a circuit switch connection is required, so that a radio network controller of a mobile radio communications device network can allocate the said at least one of the channels for circuit switched signalling exchanges, and a network controller device as claimed in any one or more of claims 3 to 6.

13-16. (canceled)
